(19) United States
(12) Patent Application Publication
(10) Pub. No.: US 2025/0208710 A1
(43) Pub. Date: Jun. 26, 2025

(54) INFORMATION PROCESSING APPARATUS, INFORMATION PROCESSING METHOD AND NON-TRANSITORY COMPUTER-READABLE MEDIUM

(71) Applicant: Yokogawa Electric Corporation, Tokyo (JP)

(72) Inventors: Kiyomi MURAOKA, Tokyo (JP); Motohiko ISHIDA, Tokyo (JP); Hirotaka YAMASHITA, Tokyo (JP); Takashi TSUBOTA, Tokyo (JP)

(21) Appl. No.: 18/916,701

(22) Filed: Oct. 16, 2024

(30) Foreign Application Priority Data
Dec. 26, 2023 (JP) 2023-219192

(51) Int. Cl. G06F 3/01; H04N 21/422

(52) U.S. Cl. CPC G06F 3/015; H04N 21/42201; G06F 2203/011

(57) ABSTRACT

Provided is an information processing apparatus including an information acquisition unit that acquires brain wave information of each of a plurality of subjects to whom content, which is common, is provided; and a content control unit that controls the content based on the brain wave information of each of the plurality of subjects and subject identification information of each of the plurality of subjects. The information processing apparatus may further include a state estimation unit that estimates a state of each of the plurality of subjects based on the brain wave information of each of the plurality of subjects. The content control unit may control the content based on the state of each of the plurality of subjects and the subject identification information.

The contents of the following patent application(s) are incorporated herein by reference: NO. 2023-219192 filed in JP on Dec. 26, 2023

### BACKGROUND

### 1. Technical Field

The present invention relates to an information processing apparatus, an information processing method and a non-transitory computer-readable medium.

### 2. Related Art

In Patent Document 1, it is described that “the reinforcement subject action can be reinforced without making a user aware of it” (Abstract). In Patent Document 2, it is described to “implement three-dimensional movement control of an operator's alter ego in a VR space” (Abstract). In Patent Document 3, “a method and a system for brain-computer interface in a headset” is described (Abstract). In Patent Document 4, it is described to be “configured to monitor an individual's brain state” (Abstract). In Patent Document 5, it is described to “integrate real-time eye movement tracking with brain activity tracking” (Abstract). In Patent Document 6, it is described to “estimate facial expressions such as joy, anger, sadness, and anger that the user wants to express” (paragraph 0019). In Patent Document 7, “a brain-machine interface device for operating a plurality of manipulated devices using a brain wave of a user” is described (claim 1). In Patent Document 8, it is described that “a robot takes appropriate actions such as a reflex” (Abstract).

### Prior Art Documents

### Patent Documents

Patent Document 1: International Publication No. 2019/082687.
Patent Document 2: Japanese Patent Application Publication No. 2022-020057.
Patent Document 3: Japanese Translation of PCT International Patent Application No. 2022-509752.
Patent Document 4: Japanese Translation of PCT International Patent Application No. 2021-511612.
Patent Document 5: Japanese Translation of PCT International Patent Application No. 2021-502659.
Patent Document 6: Japanese Patent No. 6391465.
Patent Document 7: Japanese Patent No. 6067808.
Patent Document 8: Japanese Patent Application Publication No. 2019-063905.

### BRIEF DESCRIPTION OF THE DRAWINGS

FIG. 1 shows an example of a status where content 120, which is common, is provided to a plurality of subjects 110.

FIG. 2 shows another example of a status where the content 120, which is common, is provided to the plurality of subjects 110.

FIG. 3 is a block diagram showing an example of an information processing apparatus 100 according to an embodiment of the present invention.

FIG. 4 shows an example of an information acquisition unit 10.

FIG. 5 shows an example of a state S estimated by a state estimation unit 40.

FIG. 6 shows an example of a chronological change in the subject 110 when time-series details of the content 120 are provided to the plurality of subjects 110.

FIG. 7 shows an example of the chronological change in the subject 110 when the time-series details of the content 120 are provided to the plurality of subjects 110.

FIG. 8 shows an example of groups G of the subject 110.

FIG. 9 is a flowchart showing an example of an information processing method according to an embodiment of the present invention.

FIG. 10 shows an example of a computer 2200 in which the information processing apparatus 100 according to an embodiment of the present invention may be embodied in whole or in part.

### DESCRIPTION OF EXEMPLARY EMBODIMENTS

Hereinafter, the invention will be described through embodiments of the invention, but the following embodiments do not limit the invention according to claims. In addition, not all of the combinations of features described in the embodiments are essential to the solving means of the invention.

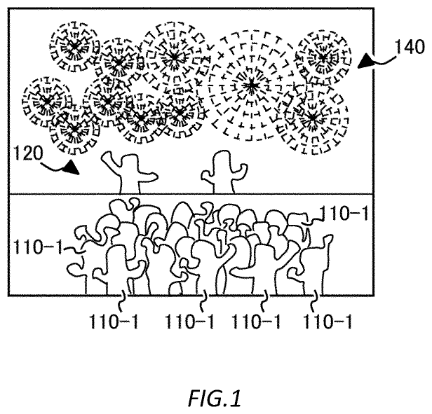

FIG. 1 shows an example of a status where content 120, which is common, is provided to a plurality of subjects 110. The content 120 is information of a viewing subject or information of an experience subject of the subjects 110. In the present specification, viewing refers to receiving a provision of video and audio of an event, etc. via a terminal 130 (described below), and experience refers to participating in the event at a venue where the event, etc. is held. In the present specification, when referring to “viewing”, it may include both “viewing” and “experience”, and when referring to “experience”, it may include both “viewing” and “experience”. Information of the viewing subject or the experience subject includes at least one of visual information or auditory information.

The content 120, which is common, may be video or audio related to the same viewing subject. The case where the content 120, which is common, is provided includes, other than a case where the same video is provided to the plurality of subjects 110, a case where a video is provided to each subject 110 when viewing the same viewing subject from different points of view and a case where the video centered on different parts of the same viewing subject is provided to each subject 110. The case where the content 120, which is common, is provided includes, other than a case where the same audio is provided to the plurality of subjects 110, a case where the same viewing subject is heard at different positions and a case where the audio generated in the same viewing subject in different positions is provided to each subject 110. The case where the content 120, which is common, is provided may refer to a status where each subject 110 participates in an event of the experience subject at the venue of the same experience subject.

In the present example, the content 120 is an event of a concert or the like. Content 120, which is common, may be provided to the plurality of subjects 110 at a common location. In the present example, the common concert is provided to the plurality of subjects 110 at a common concert venue. In the present example, staging that displays fireworks 140 is performed in a background of the concert venue.

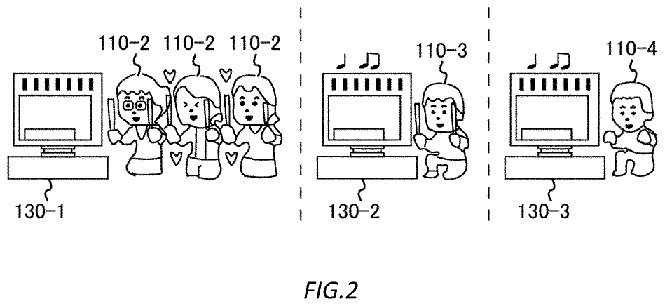

FIG. 2 shows another example of a status where the content 120, which is common, is provided to the plurality of subjects 110. The content 120, which is common, may be provided to the plurality of subjects 110 at different locations. In the present example, the common concert is provided to a subject 110-2, a subject 110-3 and a subject 110-4 at each different location.

The content 120, which is common, may be delivered on the Internet. In the present example, the content 120 shown in FIG. 1 is delivered to the subject 110-2, the subject 110-3 and the subject 110-4 on the Internet. In the present example, the subject 110 views the content 120 on a terminal 130. When the content 120 is viewed on the terminal 130, the provision of the content 120, which is common, to the plurality of subjects 110 may start at the same timing, and may end at the same timing. In another example, the provision of the content 120 to the plurality of subjects 110 may start at different timings and the provision of the content 120 may end at different timings.

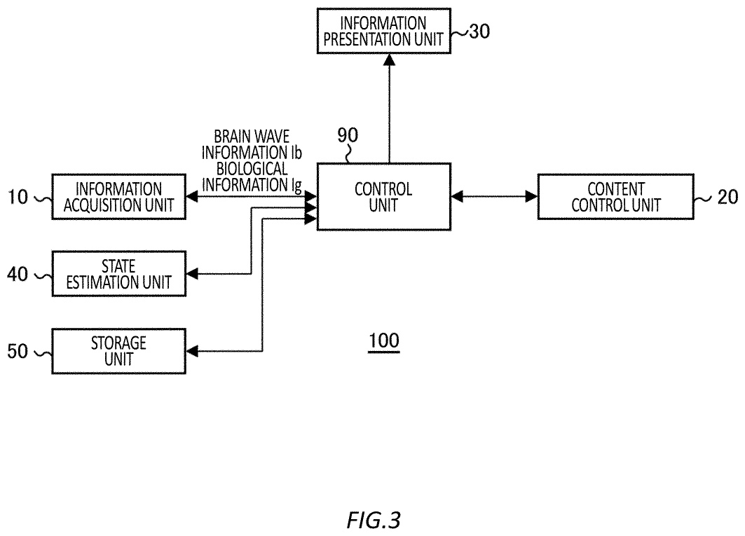

FIG. 3 is a block diagram showing an example of an information processing apparatus 100 according to an embodiment of the present invention. The information processing apparatus 100 includes an information acquisition unit 10 and a content control unit 20. The information processing apparatus 100 may include an information presentation unit 30, a state estimation unit 40, a storage unit 50 and a control unit 90.

The information processing apparatus 100 may be partially or entirely implemented by a computer. The control unit 90 may be a CPU (Central Processing Unit) of the computer. When the information processing apparatus 100 is implemented by the computer, the computer may have an evaluation support program installed thereon, so as to cause the computer to function as the information processing apparatus 100, or may have an information processing program installed thereon, so as to cause the computer to execute the information processing method described below.

The information acquisition unit 10 acquires brain wave information of each of the plurality of subjects 110 with the content 120 provided in common. The brain wave information of the subjects 110 is regarded as brain wave information Ib. The brain wave information Ib of the subjects 110 with the content 120 provided thereto refers to the brain wave information Ib of the subjects 110 during provision of the content 120. The information acquisition unit 10 may further acquire the brain wave information Ib of the subjects 110 before provision of the content 120.

The brain wave information Ib may be information reproducing at least a part of a temporal waveform of brain waves of the subjects 110. The brain wave information Ib may include data that samples the temporal waveforms of the brain waves, or may include data showing a magnitude of a frequency component of brain waves in one or more frequencies, or may include other data. For example, the brain wave information Ib includes data showing a magnitude of a component of at least one of a delta wave (lower than 4 Hz), a theta wave (equal to or higher than 4 Hz, lower than 8 Hz), an alpha wave (equal to or higher than 8 Hz, lower than 14 Hz), a beta wave (equal to or higher than 14 Hz, lower than 26 Hz) or a gamma wave (equal to or higher than 26 Hz, lower than 40 Hz).

The alpha wave may be further grouped, by the frequency band, into a low alpha wave (equal to or higher than 8 Hz, lower than 10 Hz), a medium alpha wave (equal to or higher than 10 Hz, lower than 12 Hz) and a high alpha wave (equal to or higher than 12 Hz, lower than 14 Hz). The brain wave information Ib may include data showing a magnitude of at least one of the low alpha wave, the medium alpha wave or the high alpha wave.

The beta wave may be further grouped, by the frequency band, into a low beta wave (equal to or higher than 14 Hz, lower than 18 Hz) and a high beta wave (equal to or higher than 18 Hz, lower than 26 Hz). The brain wave information Ib may include data showing a magnitude of at least one of the low beta wave or the high beta wave.

The brain wave information Ib may include information of a temporal waveform of one or more brain waves measured at one or more positions on a head, including the head region and face of the subject 110. For example, the brain wave information Ib may be acquired by measuring the temporal waveform of electric potential of electrodes arranged at a regular interval near a scalp of the subject 110, as in the International 10-20 system, or may be acquired by another method. The plurality of electrodes arranged on the scalp may be not arranged at a regular interval. The electrodes may be provided in a wearable appliance worn on the head region of the subject 110, such as a headgear, a headphone, earphones, glasses, etc. The brain wave information Ib may be information acquired by wireless communication of electrical signals at the electrodes implanted inside the subject 110's body.

The identification information of the subject 110 is regarded as subject identification information Id. The subject identification information Id may include attribute information showing an attribute of the subject 110, position information showing a position of the subject 110 in a real space or a virtual space, or information that identifies the terminal 130 of the subject 110 (see FIG. 2) with the content 120 provided thereto. The attribute information of the subject 110 is regarded as attribute information Ia. The position information of the subject 110 is regarded as position information Ip. The information that identifies the terminal 130 of the subject 110 is regarded as terminal identification information It.

The attribute information Ia may include information about the gender, age and personality of the subject 110, as well as historical information of the content 120 viewed. The personality of the subject 110 may include a susceptibility of the subject 110 to the effect of the content 120. The susceptibility to the effect of the content 120 refers to a degree of ease of affecting, when the content 120 affects a potential state of the subject 110. For example, when the content 120 is a concert, the susceptibility to the effect of the content 120 may refer to whether the subject 110 is more or less likely to be excited by excitement of the concert.

The brain wave information Ib and the subject identification information Id of the plurality of subjects 110 may be associated with each subject 110. The associated brain wave information Ib and subject identification information Id of each subject 110 may be stored in the storage unit 50.

A sum of the amplitudes of the alpha wave, the beta wave, the theta wave, the gamma wave and the delta wave at a certain timing is regarded as a total amplitude As. As one example, when the subject 110's proportion of the amplitude of the delta wave to the total amplitude As is greater than any of the proportion of the amplitude of the alpha wave to the total amplitude As, the proportion of the amplitude of the beta wave to the total amplitude As, the proportion of the amplitude of the theta wave to the total amplitude As or the proportion of the amplitude of the gamma wave to the total amplitude As, the subject 110 can be estimated to be in a sleep state.

The content control unit 20 controls the content 120 based on the brain wave information Ib of each of the plurality of subjects 110 and the subject identification information Id of each of the plurality of subjects 110. For example, when the content 120 is a concert, and when the brain wave information Ib of each of the plurality of subjects 110 is the brain wave information Ib from which the sleep state described above can be estimated, the content control unit 20 conducts control on the content 120, according to the susceptibility of the subject 110 to the effect of the content 120, to awaken from the sleep state, for example. This allows the content control unit 20 to conduct control on the content 120 according to the subject identification information Id.

The content control unit 20 may control the content 120, based on the brain wave information Ib and the subject identification information Id, which are stored in the storage unit 50 and associated with each subject 110. The brain wave information Ib and the subject identification information Id, which are stored in the storage unit 50 and associated with each subject 110, show a relationship between the subject 110 of the subject identification information Id, and the past brain wave information Ib of the subject 110. Therefore, it becomes easier for the content control unit 20 to conduct the control on the content 120, which is more appropriate to the subject 110 of the subject identification information Id, by controlling the content 120 based on the brain wave information Ib and the subject identification information Id stored in the storage unit 50.

When the content 120 is an event such as a concert, and the content 120, which is common, is provided to a plurality of subjects 110-1 at a common concert venue (the case shown in FIG. 1), the content control unit 20 controlling the content 120 may refer to performance of such staging as displaying launch of the fireworks 140 (see FIG. 1) in the background at the concert venue, changing a color of the background, etc. When the content 120 is an event such as a concert, and the plurality of subjects 110 (subjects 110-2 to subject 110-4, see FIG. 2) are viewing or experiencing the concert, which is delivered on the Internet, at different locations (the case shown in FIG. 2), the content control unit 20 controlling the content 120 may refer to performance of such staging as displaying launch of the fireworks 140 in the background, changing a color of the background, etc. of a monitor, display or the like on the terminal 130 being viewed by the subjects 110.

The state estimation unit 40 may estimate the state of each of the plurality of subjects 110, based on the brain wave information Ib of each of the plurality of subjects 110. The state is regarded as a state S. The information acquisition unit 10 may acquire the brain wave information Ib of each of the plurality of subjects 110 before provision of the content 120. The content control unit 20 may estimate the state S of each of the plurality of subjects 110, based on the change from the brain wave information Ib before provision of the content 120 to the brain wave information Ib during provision of the content 120. The content control unit 20 may control the content 120, based on the state S and the subject identification information Id of each of the plurality of subjects 110.

As one example, when the proportion of the amplitude of the theta wave to the total amplitude As during provision of the content 120 is greater than the proportion of the amplitude of the theta wave to the total amplitude As before provision of the content 120, of the subject 110, the state estimation unit 40 may estimate the state S of the subject 110 to be a state of increased fatigue and drowsiness. The content control unit 20 may conduct control on the content 120 according to, for example, the susceptibility of the subject 110 to the effect of the content 120, to relax the state S of increased fatigue and drowsiness of the subject 110.

As one example, when the proportion of the sum of the amplitude of the low alpha wave and the amplitude of the medium alpha wave to the total amplitude As of the subject 110 during provision of the content 120, is greater than the proportion of the sum to the total amplitude As before provision of the content 120, the state estimation unit 40 may estimate the state S of the subject 110 to be a state of increased degree of relaxation. The content control unit 20 may conduct control on the content 120 according to, for example, the susceptibility of the subject 110 to the effect of the content 120 to facilitate the state S where a degree of relaxation of the subject 110 is increasing.

As one example, when the proportion of the sum of the amplitude of the high alpha wave and the amplitude of the low beta wave to the total amplitude As of the subject 110 during provision of the content 120, is greater than the proportion of the sum to the total amplitude As before provision of the content 120, the state estimation unit 40 may estimate the state S of the subject 110 to be a state with a good balance between relaxation and concentration. The state with a good balance between relaxation and concentration refers to a so-called immersed state. The content control unit 20 may conduct control on the content 120 according to the susceptibility of the subject 110 to the effect of the content 120, to facilitate the state S, which is the immersed state, of the subject 110, for example.

The brain wave information Ib can reflect a potential evaluation about the content 120 of the subject 110 who has been in encounter with the content 120. The potential evaluation about the content 120 can also reflect the subject 110's own psychological state, of which he or she is unaware. The content control unit 20 controls the content 120 based on the brain wave information Ib of each of the plurality of subjects 110 and the subject identification information Id of each of the plurality of subjects 110. Therefore, the subject 110 can be provided with the control on the content 120 based on the potential evaluation about the content 120.

The brain wave information Ib, the subject identification information Id and the estimated state S of the plurality of subjects 110 may be associated with each subject 110. The associated brain wave information Ib, subject identification information Id and estimated state S of each subject 110 may be stored in the storage unit 50.

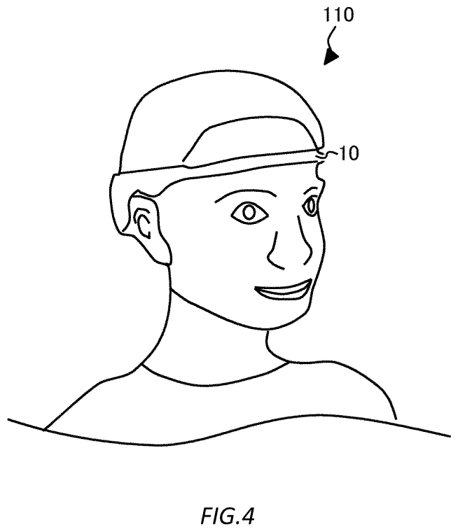

FIG. 4 shows one example of the information acquisition unit 10. The information acquisition unit 10 may have an electroencephalography capable of measuring the brain wave information Ib, or may have a communicator that acquires the brain wave information Ib measured by an external electroencephalography. The information acquisition unit 10 in the present example is a headgear-type electroencephalography. The information acquisition unit 10 may also be an earphone-type electroencephalography. In the present example, the subject 110 may have the content 120 provided thereto, in a state of wearing the headgear-type or earphone-type electroencephalography. In this manner, the information acquisition unit 10 acquires the brain wave information Ib of the subject 110 in the state having the content 120 provided thereto.

When the information acquisition unit 10 is the headgear-type electroencephalography, the content control unit 20 and the control unit 90 may be not housed in a housing of the headgear. The brain wave information Ib acquired by the information acquisition unit 10 may be transmitted to the control unit 90 wirelessly.

The information acquisition unit 10 may further acquire the biological information of each of the plurality of subjects 110 having the content 120 provided thereto. The biological information is regarded as biological information Ig. The information acquisition unit 10 may further acquire the biological information Ig before provision of the content 120. The biological information Ig may include at least one of heart rate information, perspiration amount information or body temperature information of the subject 110. The biological information Ig of the subject 110 may be acquired by a sensor provided in the wearable appliance worn by the subject 110. The information acquisition unit 10 may further acquire the biological information Ig of each of the plurality of subjects 110 before provision of the content 120.

The content control unit 20 may control the content 120 based on the brain wave information Ib and the biological information Ig of each of the plurality of subjects 110, and the subject identification information Id. The biological information Ig can reflect the potential evaluation about the content 120 of the subject 110 who has been in encounter with the content 120. For example, when the subject 110 feels stressed about the content 120, the subject 110 is likely to be in a state where a sympathetic nervous system is more dominant than a parasympathetic nervous system. When the sympathetic nervous system is more dominant than the parasympathetic nervous system, the heart rate variability of the subject 110 is likely to be smaller, and the stressed state is likely to be greater. Therefore, the content control unit 20 is capable of controlling the content 120 with the potential evaluation about the content 120 of the subject 110 being reflected more precisely, because it is based on the brain wave information Ib and the biological information Ig.

The state estimation unit 40 may estimate the state S based on the brain wave information Ib and the biological information Ig. The state estimation unit 40 may estimate the state S of each of the plurality of subjects 110, based on the change from the brain wave information Ib before provision of the content 120 to the brain wave information Ib during provision of the content 120, and the biological information Ig.

In the heart rate of the subject 110, a magnitude of a first power spectrum is regarded as LF, and a magnitude of a second power spectrum is regarded as HF. The frequency band of the second power spectrum is a frequency band of a higher frequency than the frequency band of the first power spectrum. The frequency band of the first power spectrum and the frequency band of the second power spectrum do not have to overlap. The frequency band of the first power spectrum is, for example, 0.04 to 0.15 Hz. The frequency band of the second power spectrum is, for example, 0.15 to 0.4 Hz.

The change from the proportion of the amplitude of the brain wave to the total amplitude As in a predetermined frequency band in the brain wave information Ib before provision of the content 120, to the proportion of the amplitude of the brain wave to the total amplitude As in the predetermined frequency band in the brain wave information Ib during provision of the content 120, is regarded as a change C. The state estimation unit 40 may estimate the state S based on the change C and the ratio of LF to HF (LF/HF).

As one example, when the proportion of the sum of the amplitude of the high beta wave and the amplitude of the gamma wave to the total amplitude As of the subject 110 during provision of the content 120, is greater than the proportion of the sum to the total amplitude As before provision of the content 120, and the ratio of LF to HF (LF/HF) during provision of the content 120 is equal to or greater than a threshold, it can be estimated that an irritated state, a nervous state or a stressed state of the subject 110 is increasing. When the ratio of LF to HF (LF/HF) is equal to or greater than the threshold, the subject 110 may be determined to be in a state where the sympathetic nervous system is more dominant than the parasympathetic nervous system. When the ratio of LF to HF (LF/HF) is lower than the threshold, the subject 110 may be determined to be in a state where the parasympathetic nervous system is more dominant than the sympathetic nervous system. The threshold may be 2, or may be 3, or may be 4, or may be 5.

As one example, when the proportion of the sum of the amplitude of the high beta wave and the amplitude of the gamma wave to the total amplitude As of the subject 110 during provision of the content 120, is greater than the proportion of the sum to the total amplitude As before provision of the content 120, and the ratio of LF to HF (LF/HF) during provision of the content 120 is less than the threshold, it can be estimated that an excited state of the subject 110 is increasing.

The state estimation unit 40 may estimate the state S based on a magnitude relationship between the ratio of LF to HF (LF/HF) and the threshold of the ratio of LF to HF during provision of the content 120, and the change C. The threshold may be predetermined. When the proportion of the sum of the amplitude of the high beta wave and the amplitude of the gamma wave to the total amplitude As of the subject 110 during provision of the content 120, is greater than the proportion of the sum to the total amplitude As before provision of the content 120, and the ratio of LF to HF (LF/HF) during provision of the content 120 is equal to or greater than the threshold, the state estimation unit 40 may estimate the state S where the alertness toward the content 120 of the subject 110 is increasing. When the proportion of the sum of the amplitude of the high beta wave and the amplitude of the gamma wave to the total amplitude As of the subject 110 during provision of the content 120, is greater than the proportion of the sum to the total amplitude As before provision of the content 120, and the ratio of LF to HF (LF/HF) during provision of the content 120 is less than the threshold, the state estimation unit 40 may estimate the state S where the excitement about the content 120 in increasing.

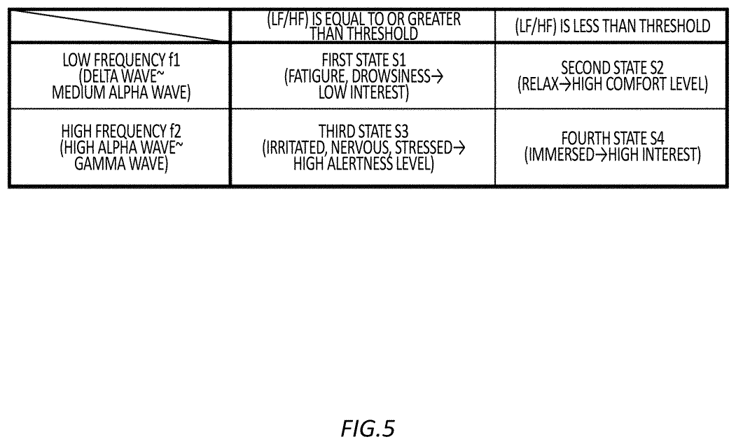

FIG. 5 shows one example of the state S estimated by the state estimation unit 40. The state S may include a plurality of states (a first state S1 to an n-th state Sn) of the subject 110. In the present example, the state S includes four states (the first state S1 to a fourth state S4) of the subject 110. In FIG. 5, a low frequency f1 brain wave refers to at least one of a delta wave, a theta wave, a low alpha wave or a medium alpha wave, and a high frequency f2 brain wave refers to at least one of a high alpha wave, a low beta wave, a high beta wave or a gamma wave.

The amplitude of the brain wave in a predetermined frequency band, which is the amplitude of the brain wave of the subject 110, is regarded as amplitude Af. The amplitude Af of the brain wave of the subject 110 before provision of the content 120 is regarded as amplitude Af1. The amplitude Af of the brain wave of the subject 110 during provision of the content 120 is regarded as amplitude Af2. The brain wave in the predetermined frequency band may be at least one of a low alpha wave, a medium alpha wave, a high alpha wave, a low beta wave, a high beta wave, a gamma wave or a theta wave.

The state estimation unit 40 may estimate the state S based on the change from proportion of the amplitude Af1 to the total amplitude As, to the proportion of the amplitude Af2 to the total amplitude As, and the ratio of LF to HF (LF/HF). The state S may be one state S of the plurality of states S (any of the first state S1 to the n-th state Sn) of the subject 110.

In the present example, the first state S1 is the state of the subject 110 when the proportion of the amplitude Af2 to the total amplitude As is greater than the proportion of the amplitude Af1 to the total amplitude As in the low frequency f1 brain wave, and the ratio of LF to HF (LF/HF) during provision of the content 120 is equal to or greater than the threshold. When the subject 110 is in the first state S1, the fatigue state and drowsiness state of the subject 110 can be estimated to be increasing. When the subject 110 is in the first state S1, the state estimation unit 40 may estimate that the subject 110's interest in the content 120 is decreasing.

In the present example, the second state S2 is the state of the subject 110 when the proportion of the amplitude Af2 to the total amplitude As is greater than the proportion of the amplitude Af1 to the total amplitude As in the low frequency f1 brain wave, and the ratio of LF to HF (LF/HF) during provision of the content 120 is less than the threshold. When the subject 110 is in the second state S2, the relax state of the subject 110 can be estimated to be increasing. When the subject 110 is in the second state S2, the state estimation unit 40 may estimate that the subject 110's comfort level toward the content 120 is increasing.

In the present example, the third state S3 is the state of the subject 110 when the proportion of the amplitude Af2 to the total amplitude As is greater than the proportion of the amplitude Af1 to the total amplitude As in the high frequency f2 brain wave, and the ratio of LF to HF (LF/HF) during provision of the content 120 is equal to or greater than the threshold. When the subject 110 is in the third state S3, the irritated state, nervous state or stressed state of the subject 110 can be estimated to be increasing. When the subject 110 is in the third state S3, the state estimation unit 40 may estimate that the subject 110's alertness level toward the content 120 is increasing.

In the present example, the fourth state S4 is the state of the subject 110 when the proportion of the amplitude Af2 to the total amplitude As is greater than the proportion of the amplitude Af1 to the total amplitude As in the high frequency f2 brain wave, and the ratio of LF to HF (LF/HF) during provision of the content 120 is less than the threshold. When the subject 110 is in the fourth state S4, the immersed state of the subject 110 can be estimated to be increasing. When the subject 110 is in the fourth state S4, the state estimation unit 40 may estimate that the subject 110's interest in the content 120 is increasing.

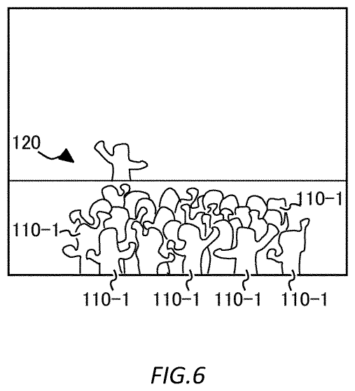

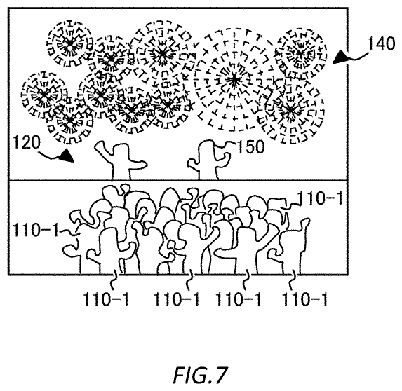

FIG. 6 and FIG. 7 show one example of a chronological change in the plurality of subjects 110 when time-series details of the content 120 are provided to the subjects 110. FIG. 6 shows one example of the subject 110 before provision of the time-series details of the content 120. FIG. 7 shows one example of the subject 110 having the time-series details of the content 120 provided thereto.

FIG. 6 and FIG. 7 show one example where the content 120 is an event such as a concert or the like. When the content 120 is an event such as a concert, the appearance of a certain performer 150 may trigger a surge of elation in the subjects 110 who are present at the concert venue, and the concert venue may suddenly become more lively. FIG. 6 shows one example of the subjects 110 before the appearance of the performer 150. FIG. 7 is one example of the subjects 110 after the appearance of the performer 150.

The information acquisition unit 10 may acquire the chronological change in the brain wave information Ib of each of the plurality of subjects 110 when the time-series details of the content 120 are provided. The state estimation unit 40 may estimate the chronological change in the state S of each of the plurality of subjects 110, based on the chronological change in the brain wave information Ib acquired by the information acquisition unit 10. The brain wave information Ib of the subject 110 may change in accordance with the change in the time-series details of the content 120. In the example shown in FIG. 6 and FIG. 7, the information acquisition unit 10 acquires the chronological change in the brain wave information Ib of each of the plurality of subjects 110, from the timing before the appearance to the timing after the appearance of a certain performer.

The state estimation unit 40 may estimate the chronological change in the state S in each of the plurality of subjects 110, based on the chronological change in the brain wave information Ib in each of the plurality of subjects 110. In the example shown in FIG. 6 and FIG. 7, the state estimation unit 40 estimates the chronological change in the state S of each of the plurality of subjects 110, from the timing before the appearance to the timing after the appearance of a certain performer.

The information presentation unit 30 may present the chronological change in the state S of each of the plurality of subjects 110, which is estimated by the state estimation unit 40. The information presentation unit 30 is, for example, a display, a monitor or the like. The information presentation unit 30 may present the chronological change in the state S to the provider of the content 120. This makes it easier for the provider of the content 120 to provide the content 120 that reflects the chronological change in the state S for each subject 110, when providing another content 120 to the subject 110 the next time. The provider of the content 120 can determine the seating arrangement of the subject 110, reflecting the chronological change in the state S, the next time the content 120 is provided to the subject 110. The provider of the content 120 can, for example, concentrate the seating arrangements of the plurality of subjects 110 with similar chronological changes in the state S in one area of the concert venue.

The state estimation unit 40 may analyze a trend in the details of the content 120 that is likely to change the state S for each subject 110, based on the chronological change in the details of the content 120 and the chronological change in the state S of the subject 110. For example, when a spotlight is shone on a particular performer in the content 120, or when a video is delivered in which the performer appears, or in which the performer is magnified, or when a video is delivered in which the performer is arranged in the center of an image, the subject 110 whose state S has changed to meet a predetermined criteria may be extracted. The extracted subjects 110 are likely to have similar preference for performers. The information presentation unit 30 may present seats adjacent to each other to the extracted subjects 110 at the next and subsequent concert venue. The arrangement of the subjects 110 with similar preferences in adjacent seats facilitates synchronization of changes in the state S of adjacent subjects 110 with respect to the content 120. This makes it easier to amplify the change in the state S of each subject 110 and to improve the satisfaction of the subjects 110.

When the content 120, which is common, is provided to the plurality of subjects 110 at different locations (the case shown in FIG. 2), the content control unit 20 may control the content 120 based on the chronological change of the state S of each of the plurality of subjects 110, which is estimated by the state estimation unit 40, and the subject identification information Id. The chronological changes of the brain wave information Ib regarding the content 120, which is common, may be different for each subject 110, when the time-series details of the content 120 are provided. Therefore, the chronological changes of states S may be different for each subject 110. In the present example, the content control unit 20 controls the content 120 based on the chronological change of the state S and the subject identification information Id. Therefore, the content control unit 20 can conduct the control optimal to the subject 110-3 to the subject 110-4 on the content 120.

In the example shown in FIG. 6 and FIG. 7, the changes of states S of the subjects 110, which are triggered by the appearance of the performer 150, may be different for each subject 110. The plurality of subjects 110 may include one subject 110 in a state S where the elation is increased in response to the appearance of the performer 150, and another subject 110 in a state S where the elation is not increased as much as the one subject 110. In the example shown in FIG. 6 and FIG. 7, the content control unit 20 makes the control on the content 120 provided to the one subject 110 different from the control on the content 120 presented to the other subject 110. Making the control on the content 120 different refers to, for example, the terminal 130 of the subject 110 (see FIG. 2) making a color of the background different, or making the staging of the background different, of the viewed monitor. This allows the content control unit 20 to conduct control that is optimal to each subject 110 on the content 120.

The content control unit 20 may enlarge different portions of the image of the viewing subject for each subject 110, and deliver the enlarged image to each terminal 130. As described above, the content control unit 20 may determine the preference for performers for each subject 110. The content control unit 20 may deliver the content 120 to the subject 110, during a period when the performer who has been determined to fit the preference is included in the delivered image, or with the performer accounting for a larger area of the image than the other performers. This allows the content control unit 20 to deliver the video according to the preference of each subject 110. The content control unit 20 may conduct the control on the content 120 wirelessly.

The chronological change of the brain wave information Ib, the chronological change of the state S, and the subject identification information Id of the plurality of subjects 110 may be respectively associated to each subject 110. The chronological change of the brain wave information Ib, the chronological change of the state S and the subject identification information Id associated to each subject 110 may be stored in the storage unit 50. The content control unit 20 may control the content 120 based on the chronological change of the state S and the subject identification information Id that are associated to each subject 110 and stored in the storage unit 50.

The content control unit 20 may control the content 120 based on the state S of each of the plurality of subjects 110 an the attribute information Ia. The attribute information Ia may include information according to the susceptibility of the subject 110 to the effect of the content 120. The susceptibility to the effect of the content 120 may be divided into levels such as large, medium and small.

The content control unit 20 may control the content 120 based on one state S of the plurality of states S and one attribute of the plurality of attributes. For example, the content control unit 20 may make the control on the content 120, when the subject 110 is in a first state S1 (a state where the interest in the content 120 is decreasing) and the susceptibility of the subject 110 is large, different from the control on the content 120, when the subject 110 is in the first state S1 (the state where the interest in the content 120 is decreasing) and the susceptibility of the subject 110 is small. This allows the content control unit 20 to conduct control on the content 120 according to the attribute of the subject 110.

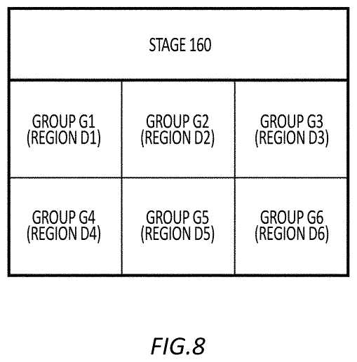

The subject identification information Id may include position information Ip showing the position of the subject 110 in the real space or the virtual space. The content control unit 20 may control the content 120 based on the brain wave information Ib and the position information Ip of each of the plurality of subjects 110. When the content 120 is an event such as a concert, and the content 120 is provided to the subjects 110 at the concert venue in the real space, the position information Ip may be information of a seating arrangement of the subjects 110 at the concert venue in the real space. The viewing ways of the performer 150 (see FIG. 7) can vary depending on the seating arrangement at the concert venue. In such a case, the content control unit 20 makes the control on the content 120 for the subject 110 regarding the position information Ip where the performer 150 is easy to see, different from the control on the content 120 for the subject 110 regarding the position information Ip where the performer 150 is difficult to see, for example. The position information Ip where the performer 150 is easy to see and the position information Ip where the performer 150 is difficult to see may be predetermined. For example, when the performer 150 is in front of a region D3 on the stage 160 (see FIG. 8), the region D3 and a region D6 may be predetermined as positions where the performer 150 is easy to see, and a region D1 may be predetermined as a position where the performer 150 is difficult to see. The predetermined position information Ip may be stored in the storage unit 50.

The content control unit 20 making the control on the content 120 different may include making the presence or absence of the display of fireworks 140 (see FIG. 7) on the background of the performer 150 different, making the color of the fireworks 140 different, making the color of the background different or the like. When the performer 150 is in front of the region D3, the content control unit 20 displays the fireworks 140 on the background of the performer 150, and does not display the fireworks 140 on the background of the stage 160 in front of the region D1, for example.

FIG. 8 shows one example of groups G of the subjects 110. FIG. 8 is a top view of the concert venue in the real space shown in FIG. 1, FIG. 6 and FIG. 7. A plurality of regions D may be set in the real space or the virtual space where the subjects 110 exists. In the example in FIG. 8, six regions D (a region D1 to a region D6) are set at the concert venue in the real space. In the example in FIG. 8, the stage 160 on which the performer 150 takes the stage is arranged in front of the six regions D. The plurality of subjects 110 exist in each of the plurality of regions D.

The state estimation unit 40 may estimate a state of the groups G of the plurality of subjects 110 in each of the plurality of regions D, based on the brain wave information Ib of the plurality of subjects 110 in each of the plurality of regions D. The state of the group G is regarded as a state S′. In the present example, the state estimation unit 40 estimates the state S′ of each of a group G1 to a group G6.

The state estimation unit 40 may estimate the state S of each subject 110, and estimate the state S′ of the group based on the state S of each subject 110, in each of the plurality of regions D. The state estimation unit 40 may estimate, for each subject 110, whether the state S of the subject 110 is any of the state S1 to the state S4 (see FIG. 5), in each of the plurality of regions D. The state estimation unit 40 may estimate the state S, which is the most among the state S1 to the state S4 in one region D, as the state S′ of the group of the subjects 110 in the one region D. In the example shown in FIG. 8, the state S′ of the group G1 in the region D1 is regarded as a state where the interest in the content 120 is increasing, the state S′ of the group G3 in the region D3 is regarded as a state where the interest in the content 120 is decreasing.

The content control unit 20 may control the content 120 based on the state S′ of the group G. The content control unit 20 may control volume, temperature or light intensity for each region D according to the state S′ of the group G. In the example shown in FIG. 8, the content control unit 20 conducts the control on the light intensity that increases the interest for the group G3 in the region D3 with decreasing interest. The content control unit 20 may increase the interest of the group G3 by performing the control such as spotlighting the stage in front of the region D3, for example.

In the example shown in FIG. 8, when the interest of the group G1 in the region D1 is excessively increasing, the content control unit 20 may provide information to a security system at the concert venue that the interest of the group G1 is excessively increasing. When the interest in the content 120 is excessively increasing, there may be a risk of over-enthusiasm by the subject 110. Therefore, the content control unit 20 may provide information to the security system at the concert venue that the interest of the group G1 is excessively increasing.

The information presentation unit 30 may present the state S′ of the group G to the provider of the content 120 in each region D. The information presentation unit 30 may present the state S′ of the group G in each region D in a color gradation across the plurality of regions D.

The content control unit 20 may control the content 120 based on the state S′ of the group G and the position information Ip. When it is possible to independently control each background of the stage 160 in front of each of the region D1 to the region D3, the content control unit 20 may control the background of each stage 160 in front of each of the region D1 to region D3, based on the state S′ of each of the group G1 to group G3. For example, with the performer 150 (see FIG. 7) moving to front of the region D3, when the state S′ of the group G3 becomes a state where the interest in the content 120 is increasing, and the state S′ of the group G1 becomes a state where the interest in the content 120 is decreasing, the content control unit 20, for example, displays the fireworks 140 on the background of the stage 160 in front of the region D3, and does not display the fireworks 140 on the background of the stage 160 in front of the region D1.

In one region D of the plurality of regions D, when the change of the state S of one subject 110 is different from the change of the state S of another subject 110 from the timing before provision of the content 120 to the timing after provision of the content 120, the information presentation unit 30 may present, to the one subject 110, the content 120 that recommends to move to a different region D from the one region D. In one region D of the plurality of regions D, when the change of the state S of one subject 110 is different from the change of the state S of another subject 110 from the timing before provision of the content 120 to the timing after provision of the content 120, and the state S of the one subject 110 is the same as the state S of the other subject 110 after provision of the content 120, the information presentation unit 30 may present, to the one subject 110, the content 120 that recommends to move to a different region D from the one region D. When the plurality of subjects 110 exist in one region D, the change of the state S of one subject 110 in the one region D may be different from the change of the state S of another plurality of subjects 110 in the one region D. For example, with the appearance of the performer 150 (see FIG. 7), when one subject 110 changes from the state S4 to the state S2, regardless of the change from the state S1 to the state S2 of another plurality of subjects 110, the interest in the performer 150 of the other plurality of subjects 110 is increasing, but the interest in the performer 150 of the one subject 110 is highly likely to decrease. In such a case, the information presentation unit 30 may present, to one subject 110, the content 120 that recommends to move to a different region D from one region D.

The subject identification information Id may include terminal identification information It that identifies the terminal 130 of the subject 110 (see FIG. 2). The content control unit 20 may control the content 120 based on the brain wave information Ib of each of the plurality of subjects 110 and the terminal identification information It. When the content 120, which is common, at different locations is provided to the plurality of subjects 110 (the case shown in FIG. 2), the content control unit 20 may control the content 120 based on the brain wave information Ib of one subject 110 at one location and the terminal identification information It of the one subject 110, and may control the content 120 based on the brain wave information Ib of another subject 110 at another location and the terminal identification information It of the other subject 110.

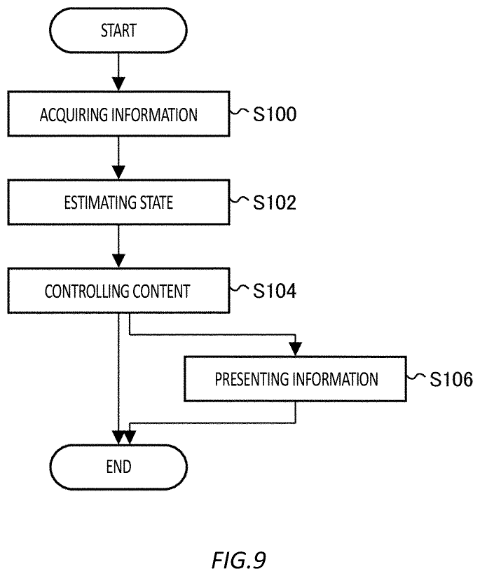

FIG. 9 is a flowchart showing one example of an information processing method according to one embodiment of the present invention. The information processing method according to one embodiment of the present invention describes the information processing apparatus 100 shown in FIG. 3 as an example. The information processing method includes acquiring information S100 and controlling content S104. The information processing method may include estimating a state S102 and presenting information S106.

Acquiring information S100 is a step in which the information acquisition unit 10 acquires the brain wave information Ib of each of the plurality of subjects 110 provided with the content 120, which is common. Controlling content S104 is a step in which the content control unit 20 controls the content 120 based on the brain wave information Ib of each of the plurality of subjects 110 and the subject identification information Id of each of the plurality of subjects 110.

Estimating a state S102 is a step in which the state estimation unit 40 estimates the state S of each of the plurality of subjects 110, based on the brain wave information Ib of each of the plurality of subjects 110. Controlling the content S104 may be a step in which the content control unit 20 controls the content 120 based on the state S and the subject identification information Id of each of the plurality of subjects 110.

Acquiring the information S100 may be a step in which the information acquisition unit 10 further acquires the biological information Ig of each of the plurality of subjects 110 provided with the content 120. Controlling the content S104 may be a step in which the content control unit 20 controls the content 120, based on the brain wave information Ib and the biological information Ig of each of the plurality of subjects 110 and the subject identification information Id.

Estimating the state S102 may be a step in which the state estimation unit 40 estimates the state S, based on the change from the proportion of the amplitude Af1 to the total amplitude As in the brain wave information Ib before provision of the content 120, to the proportion of the amplitude Af2 to the total amplitude As in the brain wave information Ib during provision of the content 120, and the ratio of LF to HF (LF/HF) in the heart rate of the subject 110.

Estimating the state S102 may be a step in which the state estimation unit 40 estimates the state S, based on the magnitude relationship between the ratio of LF to HF (LF/HF) and the predetermined threshold of the ratio of LF to HF (LF/HF) during provision of the content 120, and the change from the proportion of the amplitude Af1 to the total amplitude As to the proportion of the amplitude Af2 to the total amplitude As.

The state S may include a plurality of states of the subject 110. Estimating the state S102 may be a step in which the state estimation unit 40 estimates one state S of the plurality of states S, based on the change from the proportion of the amplitude Af1 to the total amplitude As to the proportion of the amplitude Af2 to the total amplitude As, and the ratio of LF to HF (LF/HF).

Acquiring the information S100 may be a step in which the information acquisition unit 10 acquires the chronological change of the brain wave information Ib of each of the plurality of subjects 110 when the time-series details of the content 120 has been provided. Estimating the state S102 may be a step in which the state estimation unit 40 estimates the chronological change of the state S in each of the plurality of subjects 110, based on the chronological change of the brain wave information Ib.

Controlling the content S104 may be a step in which the content control unit 20 controls the content 120 based on the state S and the attribute information Ia of each of the plurality of subjects 110. Controlling the content S104 may be a step in which the content control unit 20 controls the content, based on the brain wave information Ib and the position information Ip of each of the plurality of subjects 110. Controlling the content S104 may be a step in which the content control unit 20 controls the content 120 based on the brain wave information Ib and the terminal identification information It of each of the plurality of subjects 110.

Estimating the state S102 may be a step in which the state estimation unit 40 estimates the state S′ of the group G of the plurality of subjects 110 in each of the plurality of regions D, based on the brain wave information Ib of the plurality of subjects 110 in each of the plurality of regions D. Presenting the information S106 may be a step in which when the brain wave information Ib of one subject 110 deviates from the brain wave information Ib of another subject 110 in one region D, the information presentation unit 30 presents the content 120 that recommends to move to a different region D from the one region D to the one subject 110, based on the level of divergence between the brain wave information Ib of the one subject 110 and the brain wave information Ib of the other subject 110. Controlling the content S104 may be a step in which the content control unit 20 controls the information presentation unit 30 in order to present the content 120 to the information presentation unit 30.

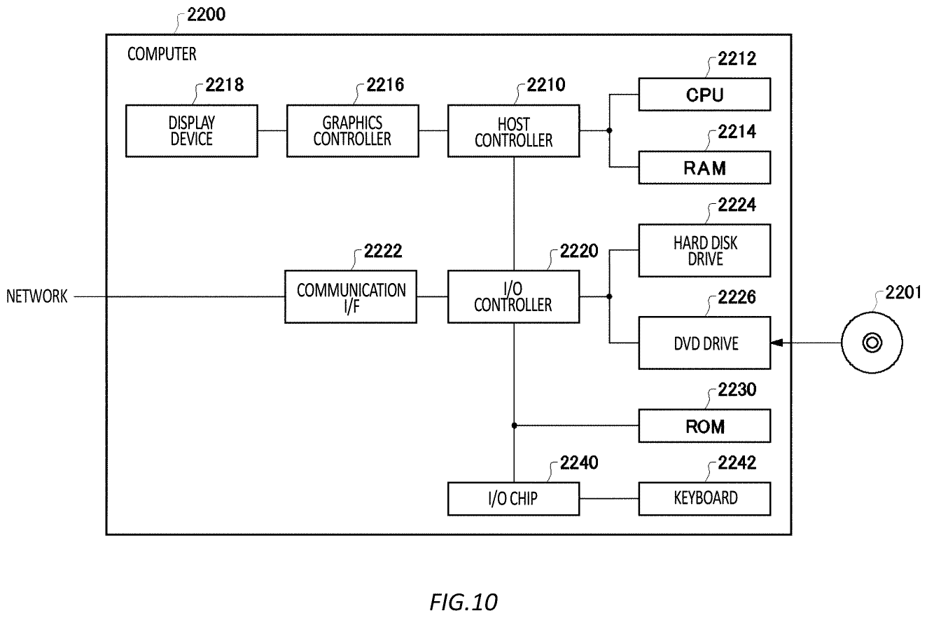

FIG. 10 shows one example of a computer 2200 in which the information processing apparatus 100 according to an embodiment of the present invention may be embodied in whole or in part. A program installed on the computer 2200 can cause the computer 2200 to function as operations associated with information processing apparatus 100 or one or more sections of the information processing apparatus 100 according to an embodiment of the present invention, or can cause the computer to execute the operations or the one or more sections, or can cause the computer 2200 to execute each level according to the information processing method of the present invention (see FIG. 9). The program may be executed by the CPU 2212 in order to cause the computer 2200 to execute particular operations associated with some or all of the blocks in the flowchart (FIG. 9) and the block diagram (FIG. 3) described in the present specification.

The computer 2200 according to one embodiment of the present invention includes a CPU 2212, a RAM 2214, a graphics controller 2216 and a display device 2218. The CPU 2212, the RAM 2214, the graphics controller 2216 and the display device 2218 are interconnected by the host controller 2210. The computer 2200 further include an input/output unit such as a communication interface 2222, a hard disk drive 2224, a DVD-ROM drive 2226, an IC card drive and so on. The communication interface 2222, the hard disk drive 2224, the DVD-ROM drive 2226, the IC card drive and so on are connected to the host controller 2210 via the input/output controller 2220. The computer further includes a legacy input/output unit such as a ROM 2230 and a keyboard 2242. The ROM 2230, the keyboard 2242 and so on are connected to the input/output controller 2220 via the input/output chip 2240.

The CPU 2212 controls each unit by operating in accordance with the program stored in the ROM 2230 and the RAM 2214. The graphics controller 2216 acquires the image data generated by the CPU 2212, such as a frame buffer provided in the RAM 2214 or in the RAM 2214, so that the image data is displayed on the display device 2218.

The communication interface 2222 communicates with other electronic devices via a network. The hard disk drive 2224 stores the program and data used by the CPU 2212 in the computer 2200. The DVD-ROM drive 2226 reads the program or data from the DVD-ROM 2201 and provides the read program or data to the hard disk drive 2224 via the RAM 2214. The IC card drive reads the program and data from the IC card or write the program and data to the IC card.

The ROM 2230 stores the program, such as a boot program, which is executed by the computer 2200 upon activation, or which is dependent on the hardware of the computer 2200. The input/output chip 2240 may connect various input/output units to the input/output controller 2220 via parallel ports, serial ports, keyboard ports, mouse ports and so on.

The program is provided by a computer readable medium such as the DVD-ROM 2201 or the IC card. The program is read from the computer readable medium, and is installed in the hard disk drive 2224, the RAM 2214 or the ROM 2230 that are also examples of the computer readable medium, and executed by the CPU 2212. The Information processing described within these programs is read by the computer 2200 and results in linkages between the programs and the various types of hardware resources described above. The device or method may be configured, in accordance with the use of the computer 2200, by implementing the operations or processing of information.

For example, when communication is to be executed between the computer 2200 and an external device, the CPU 2212 may execute a communication program loaded into the RAM 2214 and order communication processing to the communication interface 2222 based on the processing described in the communication program. The communication interface 2222, under the control of the CPU 2212, reads transmission data stored in a transmission buffer processing region provided in a recording medium such as the RAM 2214, the hard disk drive 2224, the DVD-ROM 2201 or the IC card, transmits the read transmission data to the network, or writes the received data received from the network to a receive buffer processing region provided on the recording medium or the like.

The CPU 2212 may allow all or necessary portions of files or databases stored on an external recording medium such as the hard disk drive 2224, a DVD-ROM drive 2226 (a DVD-ROM 2201), an IC card or the like to be read into the RAM 2214. The CPU 2212 may execute various types of processing on the data in the RAM 2214. The CPU 2212 may then write back the processed data to the external recording medium.

Various types of information, such as various types of programs, data, tables and databases, may be stored on the recording medium and information may be processed. The CPU 2212 may execute various types of processing on the data read from the RAM 2214, including various types of operations, information processing, conditional decisions, conditional branching, unconditional branching, information retrieval or replacement, etc., as described in this disclosure and designated by the program instruction sequence. The CPU 2212 may write back results to the RAM 2214.

The CPU 2212 may retrieve information in the files, databases or the like inside the recording medium. For example, when a plurality of entries, each having an attribute value of the first attribute associated with the attribute value of the second attribute, are stored in the recording medium, the CPU 2212 may retrieve, among the plurality of entries for an entry that matches the condition, wherein the attribute value of the first attribute is designated, and may read the attribute value of the second attribute stored in the entry and acquire the attribute value of the second attribute associated with the first attribute that meets the predetermined condition by reading the second attribute value.

The program or software module described above may be stored on the computer 2200 or on the computer readable medium on the computer 2200. The recording medium such as a hard disk or RAM provided within a server system connected to a dedicated communication network or the Internet can be used as the computer readable medium. The program may be provided to the computer 2200 by the recording medium.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: information acquisition unit; 20: content control unit; 30: information presentation unit; 40: state estimation unit; 50: storage unit; 90: control unit; 100: information processing apparatus; 110: subject; 120: content; 130: terminal; 140: firework; 150: performer; 160: stage; 2200: computer; 2201: DVD-ROM; 2210: host controller; 2212: CPU; 2214: RAM; 2216: graphics controller; 2218: display device; 2220: input/output controller; 2222: communication interface; 2224: hard disk drive; 2226: DVD-ROM drive; 2230: ROM; 2240: input/output chip; 2242: keyboard.

What is claimed is:

1. An information processing apparatus, comprising:
an information acquisition unit that acquires brain wave information of each of a plurality of subjects to whom content, which is common, is provided; and
a content control unit that controls the content based on the brain wave information of each of the plurality of subjects and subject identification information of each of the plurality of subjects.

2. The information processing apparatus according to claim 1, further comprising
a state estimation unit that estimates a state of each of the plurality of subjects based on the brain wave information of each of the plurality of subjects,
wherein the content control unit controls the content based on the state of each of the plurality of subjects and the subject identification information.

3. The information processing apparatus according to claim 2, wherein:
the information acquisition unit further acquires biological information of each of the plurality of subjects provided with the content; and
the content control unit controls the content based on the brain wave information and the biological information of each of the plurality of subjects, and the subject identification information.

4. The information processing apparatus according to claim 3, wherein:
the information acquisition unit further acquires the brain wave information before and during provision of the content; and
the state estimation unit estimates the state of each of the plurality of subjects based on a change from the brain wave information before provision of the content to the brain wave information during provision of the content, and the biological information.

5. The information processing apparatus according to claim 4, wherein:
the state estimation unit estimates the state based on a change, which is from a proportion of an amplitude of a brain wave in a predetermined frequency band to a total amplitude in the brain wave information before provision of the content, to a proportion of the amplitude of the brain wave in the predetermined frequency band to the total amplitude in the brain wave information during provision of the content, and a proportion of a magnitude of a first power spectrum to a magnitude of a second power spectrum in a heart rate of the subject, the subject being included in the plurality of subjects;
the total amplitude is a sum of amplitudes of an alpha wave, a beta wave, a theta wave, a gamma wave and a delta wave; and
a frequency band of the second power spectrum is a frequency band of a higher frequency than a frequency band of the first power spectrum.

6. The information processing apparatus according to claim 5, wherein the state estimation unit estimates the state based on a magnitude relationship between a proportion of a magnitude of the first power spectrum to a magnitude of the second power spectrum during provision of the content and a predetermined threshold of the proportion of the magnitude of the first power spectrum to the magnitude of the second power spectrum, and the change.

7. The information processing apparatus according to claim 5, wherein:
the state includes a plurality of states of the subject, the subject being included in the plurality of subjects; and
the state estimation unit estimates one of the state among the plurality of states based on the change and the proportion of the magnitude of the first power spectrum to the magnitude of the second power spectrum.

8. The information processing apparatus according to claim 7, wherein a brain wave of the predetermined frequency band is at least one of a delta wave, a theta wave, a low alpha wave or a medium alpha wave.

9. The information processing apparatus according to claim 7, wherein the brain wave of the predetermined frequency band is at least one of a high alpha wave, a low beta wave, a high beta wave or a gamma wave.

10. The information processing apparatus according to claim 2, wherein:
the information acquisition unit acquires a chronological change in the brain wave information of each of the plurality of subjects when time-series details of the content is provided; and
the state estimation unit estimates the chronological change in the state in each of the plurality of subjects based on the chronological change in the brain wave information.

11. The information processing apparatus according to claim 3, wherein:
the information acquisition unit acquires a chronological change in the brain wave information of each of the plurality of subjects when time-series details of the content is provided; and
the state estimation unit estimates the chronological change in the state in each of the plurality of subjects based on the chronological change in the brain wave information.

12. The information processing apparatus according to claim 2, wherein:
the subject identification information includes attribute information representing an attribute of the subject, the subject being included in the plurality of subjects; and
the content control unit controls the content based on the state of each of the plurality of subjects and the attribute information.

13. The information processing apparatus according to claim 3, wherein:
the subject identification information includes attribute information representing an attribute of the subject, the subject being included in the plurality of subjects; and
the content control unit controls the content based on the state of each of the plurality of subjects and the attribute information.

14. The information processing apparatus according to claim 2, wherein:
the subject identification information includes position information representing a position of the subject in a real space or a virtual space, the subject being included in the plurality of subjects; and
the content control unit controls the content based on the brain wave information and the position information.

15. The information processing apparatus according to claim 3, wherein:
the subject identification information includes position information representing a position of the subject in a real space or a virtual space, the subject being included in the plurality of subjects; and
the content control unit controls the content based on the brain wave information and the position information.

16. The information processing apparatus according to claim 14, wherein:
a plurality of regions are set in the real space or the virtual space; and
the state estimation unit estimates a state of a group of the plurality of subjects in each of the plurality of regions, based on the brain wave information of the plurality of subjects, in each of the plurality of regions.

17. The information processing apparatus according to claim 1, wherein:
the subject identification information includes terminal identification information that identifies a terminal of the subject, the subject being included in the plurality of subjects, which is provided by the content; and
the content control unit controls the content based on the brain wave information and the terminal identification information.

18. The information processing apparatus according to claim 2, wherein:
the subject identification information includes terminal identification information that identifies a terminal of the subject, the subject being included in the plurality of subjects, which is provided by the content; and
the content control unit controls the content based on the brain wave information and the terminal identification information.

19. An information processing method, comprising:
acquiring, by an information acquisition unit, brain wave information of each of a plurality of subjects provided with content which is common; and
controlling, by a content control unit, the content, based on the brain wave information of each of the plurality of subjects and subject identification information of each of the plurality of subjects.

20. A non-transitory computer-readable medium having recorded thereon an information processing program which, when executed by a computer, causes the computer to perform:
acquiring brain wave information of each of a plurality of subjects provided with content which is common; and
controlling the content, based on the brain wave information of each of the plurality of subjects and subject identification information of each of the plurality of subjects.
